(19) United States
(12) Patent Application Publication
(10) Pub. No.: US 2002/0152320 A1
(43) Pub. Date: Oct. 17, 2002

(54) System and method for rapidly switching between redundant networks

(76) Inventor: Pui Lun Lau, Farmington, CT (US)

Correspondence Address: THOMAS M. BLASEY, HUNTON & WILLIAMS, 1900 K STREET, N.W., WASHINGTON, DC, 20006-1109, US

(21) Appl. No.: 09/776,944

(22) Filed: Feb. 14, 2001

(51) Int. Cl. G06F 15/173

(52) U.S. Cl. 709/238

(57) ABSTRACT

A system and method for rapidly switching between redundant networks comprises a primary network controller, a plurality of network devices connected to the primary network controller by a respective primary network path, and at least one predetermined backup network path. When the primary network path is active, the network controller blocks the predetermined backup network paths. However, when the primary network path fails, the primary network controller blocks the failed primary network path and switches to one of the predetermined backup network paths. Because the backup network paths are determined in advance of a primary network path failure, the primary network controller can immediately switch to one of the predetermined backup network paths rather than having to recalculate an alternative network path after the primary network path has failed.

### BACKGROUND OF THE INVENTION

This invention relates to network systems and, more particularly, to a system and method for rapidly switching between redundant networks.

Networks may be expanded by using one or more repeaters, bridges, switches or similar types of devices. A repeater is a device that moves all packets from one network segment to another by regenerating, re-timing, and amplifying the electrical signals. A bridge is a device that operates at the Data-Link Layer of the OSI (Open Systems Interconnection) Reference Model, passes packets from one network to another, and increases efficiency by filtering packets to reduce the amounts of unnecessary packet propagation on each network segment. A switch is similar in function to a multiple port bridge, but includes a plurality of ports for directing network traffic among several similar networks. A repeater or a switch may also include a second set of ports for coupling to higher speed network devices, such as one or more uplink ports.

Expansion of a network often results in loops that cause undesired duplication and transmission of network packets such as broadcast storms, as well as address conflict problems. A standard spanning tree procedure has been defined for network bridging devices, such a bridges, routers, and switches, to enable the bridging devices of a network to dynamically discover a subset of any topology that forms a loop-free or “spanning” tree. A spanning tree procedure by the American National Standards Institute and the Institute of Electrical and Electronics Engineers, Inc. is published in a specification known as the ANSI/IEEE Std. 802.1D.

The spanning tree procedure results in a network path between any two devices in the network system, which is updated dynamically in response to modifications of the network system. Each bridging device transmits configuration messages, which are use by other bridging devices in the network to determine the spanning tree.

One problem with spanning tree procedures is the amount of time it takes to reconfigure the spanning tree topology if there is a bridge or a data-path failure. Whenever there is a bridge or data-path failure, the spanning tree algorithm must be executed to determine an alternative network path. Depending upon the size of the network, the spanning tree calculations could take as long as two minutes to complete. This delay in reconfiguring the network is unacceptable in networks that support certain mission-critical applications, such as control and data acquisition system for electrical power grids.

### BRIEF SUMMARY OF THE INVENTION

In an exemplary embodiment of the invention, a network comprises a primary network controller, a plurality of network devices connected to the primary network controller by a respective primary network path, and at least one predetermined backup network path. When the primary network path is active, the network controller blocks the predetermined backup network paths. However, when the primary network path fails, the primary network controller blocks the failed primary network path and switches to one of the predetermined backup network paths.

Because the backup network paths are determined in advance of a primary network path failure, the primary network controller can immediately switch to one of the predetermined backup network paths rather than having to recalculate an alternative network path after the primary network path has failed.

The invention also provides a control and data acquisition system, comprising at least one network controller, a plurality of data terminal equipment (DTE) devices, respective primary network paths connecting each DTE device with the at least one network controller, and predetermined backup network paths connecting each DTE device with the at least one network controller. Each predetermined backup network path is blocked by the at least one network controller when a corresponding primary network path is active. However, when a primary network path fails, the at least one network controller blocks the failed primary network path and switches to one of the predetermined backup paths.

The invention also provides a method of implementing a network, comprising the steps of determining a primary network path between a network controller and a network devices determining, prior to a failure of the primary network path, a backup network path between the network controller and the network device, monitoring the status of the primary network path, blocking the backup network path while the primary network path is active, and blocking the primary network path and making the backup network path active when the primary network path fails.

### BRIEF DESCRIPTION OF THE DRAWINGS

FIG. 1 is a block diagram of a network in accordance with one embodiment of the present invention;

FIG. 2 is a block diagram of a control and data acquisition system, in accordance with one embodiment of the present invention;

FIG. 3 is a flowchart of a preferred control routine for the network controllers shown in FIGS. 1 and 2 and

FIG. 4 is a flowchart of a preferred control routine for testing backup network paths.

### DETAILED DESCRIPTION OF THE INVENTION

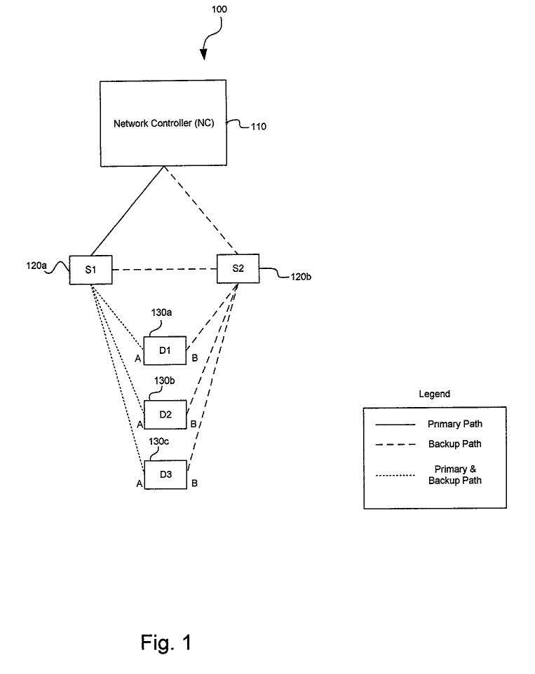

FIG. 1 shows a network 100, in accordance with one embodiment of the present invention. The network 100 includes a network controller 110, bridging devices 120a and 120b, and network devices 130a, 130b and 130c.

Only two bridging devices 120a and 120b and three network devices 130a, 130b and 130c are shown for purposes of illustration. It should be appreciated that larger networks incorporating any combination of bridging devices and network devices can be used while still falling within the scope of the present invention.

Bridging devices 120a and 120b refer to any type of bridging or switching device, such as bridges, switches, repeater, routers, brouters, etc. Network devices, 130a, 130b and 130c are preferably any type of Data Terminal Equipment (DTE) device. A DTE device refers to any source of or destination for data. Examples of DTE devices include universal relays, process control equipment, and computer systems. The network devices 130a-130c preferably contain at least two data ports, which are shown in FIG. 1 as the letters “A” and “B” next to each network device.

The network controller 110 preferably executes routines for communicating with network devices 130a-130c, and for determining which network path is used to communicate with the network devices 130a-130c.

For purposes of illustrating and describing the various network paths in the network 100 the network controller 110 will also be referred to as NC the bridging devices 120a and 120b will also be referred to as S1 and S2 respectively, and the network devices 130a, 130b and 130c will also be referred to as D1, D2 and D3, respectively. Further, the primary network paths are indicated with solid lines, the backup network paths are indicated with dashed lines and paths that are used both as a primary and a backup path are indicated by dotted lines.

In operation, the network controller 110 establishes primary network paths to the network devices 130a-130c. In the example shown, the primary network path between the network controller 110 and network device 130a is NC-S1-D1A. The terminology “D1A” refers to port “A” in network device D1 (130a).

In the example shown, the primary network paths between the network controller 110 and network devices 130b and 130c are NC-S1-D2A, and NC-S1-D3A, respectively. As long as connection NC-S1 is operational, the network controller 110 will block corresponding predetermined backup paths NC-S2-S1-D1A, NC-S2-S1-D2A and NC-S2-S1-D3A by blocking the connection between S1 and S2. These backup network paths are predetermined, in that they are calculated and stored in the network controller 110 before the failure of any of the primary network paths. By blocking the S1-S2 connection, loops between the network controller 110 and the bridging devices 120a and 120b are avoided.

If the NC-S1 connections fails, the network controller will enable the S1-S2 connection, thereby enabling the predetermined backup network paths NC-S2-S1-D1A, NC-S2-S1-D2A and NC-S2-S1-D3A. If the “A” data port on one of the network devices fails, the network device will preferably switch to the “B” data port, and another predetermined backup network path will be enabled. For example, if data port “A” in network device 130a fails, the network device 130a will preferably switch to the “B” data port, and predetermined backup network path NC-S1-S2-D1B between the network controller 110 and network device 130a will be enabled.

As discussed above, any combination of bridging devices and network devices can be used while still falling within the scope of the present invention. In addition, one or more additional network controllers can be used as a backup to the network controller 110. If additional network controllers are used, the additional network controllers will each have predetermined primary and backup network paths to the network devices 130a-130c, so that one of the additional network controllers can take over control of the network 100 if the primary network controller 110 fails.

In a preferred embodiment, the network controller 110 periodically tests the status of the backup network paths. This is preferably accomplished by disabling the primary network paths and querying the network devices 130a-130c via the backup network paths. The test procedure is preferably done periodically to ensure that the backup network paths will be operational when a primary network path goes down.

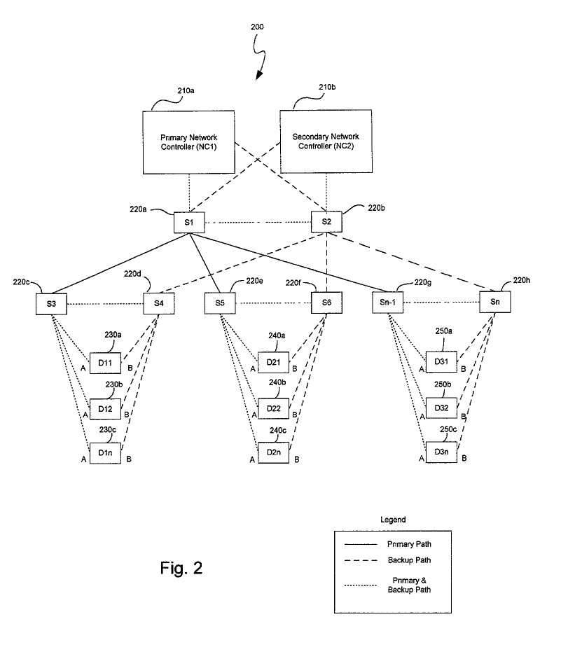

FIG. 2 illustrates a control and data acquisition system 200, in accordance with one embodiment of the present invention. The system 200 comprises a primary network controller 210a, a secondary network controller 210b, bridging devices 220a-220h, and network devices 230a-230c, 240a-240c and 250a-250c.

Similar to the system of FIG. 1, the primary network controller 210a and a secondary network controller 210b will also be referred to as NC1 and NC2, respectively, when discussing primary and backup network paths. In addition, bridging devices 220a-220f will also be referred to as S1-S6, and bridging devices 220g and 220h will also be referred to as Sn−1 and Sn. The terminology “Sn−1” and “Sn” is used to indicate that any number of bridging devices and associated network devices can be used while still falling within the scope of the present invention.

Further, network devices 230a, 230b and 230c will also be referred to as D11, D12 and D1n, network devices 240a, 240b and 240c will also be referred to as D21, D22 and D2n, and network devices 250a, 250b and 250c will also be referred to as D31, D32 and D3n. The terminology “D1n”, “D2n” and “D3n” is used to indicate that any number of network devices can be connected to each bridging device while still falling within the scope of the present invention.

Similar to the system of FIG. 1, solid lines indicate primary network paths, and dashed lines indicate backup network paths. Further, dotted lines indicate paths that are used both as a primary and a backup network paths.

The primary network controller 210a and the secondary network controller 210b each preferably contain control routines for communicating with the various network devices 230a-250c and for determining which network path is used to communicate with the network devices 230a-250c. The primary network controller 210a is preferably the default network controller, and the secondary network controller 210b is preferably used if the primary network controller 210a fails.

The network devices 230a-250c care preferably data acquisition and control devices, such as universal relays and process control equipment. However, network devices 230a-250c can be any DTE device. For illustration, network devices 230a-250c are each depicted as having two data ports (“A” and “B”).

In operation, the primary network controller 210a and the secondary network controller 210b each establish primary network paths and backup network paths to each of the various network devices 230a-250c. Examples of various failure modes are listed in the table below, along with the actions taken by the primary and secondary network controllers 210a and 210b. It should be appreciated that not all possible failure modes are listed, and that other primary/backup network path configurations can be used while still falling within the scope of the present invention.

The sample failure modes listed in the table below are for communication failures between network controllers 210a, 210b and network device 230a. Further, it is assumed that the primary network paths between the primary network controller 210a and network device 230a is NC1-S1-S3-D1A, and the primary network path between the secondary network controller 210b and network device 230a is NC2-S2-S1-S3-D1A.

| | Failure Mode | Action |
|---|---|---|
| (1) | S1-S2 | (1) If NC1 in control: maintain primary network |
| | Connection Fails | path NC1-S1-S3-D1A, and trigger alarm in |
| | | human machine interface. |
| | | (2) If NC2 in control: switch to backup network |
| | | path NC2-S2-S4-S3-D1A, and trigger alarm in |
| | | human machine interface. |
| (2) | S1 Fails | (1) If NC1 in control: disable node S1, switch to |
| | | backup network path NC1-S2-S4-S3-D1A, and |
| | | trigger alarm in human machine interface. |
| | | (2) If NC2 in control: disable node S1, switch to |
| | | backup network path NC2-S2-S4-S3-D1A, and |
| | | trigger alarm in human machine interface. |
| (3) | S1-S3 | (1) If NC1 in control: disable S1-S3 port in |
| | Connection Fails | node S1, switch to backup network path |
| | | NC1-S1-S2-S4-S3-D1A, and trigger alarm |
| | | in human machine interface. |
| | | (2) If NC2 in control: disable S1-S3 port in |
| | | node S1, switch to backup network path |
| | | NC2-S2-S4-S3-D1A, and trigger alarm |
| | | in human machine interface. |
| (4) | S3 Fails | (1) If NC1 in control: disable S1-S3 port in |
| | | node S1, switch to backup network |
| | | path NC1-S1-S2-S4-D1B, and |
| | | trigger alarm in human machine interface. |
| | | (2) If NC2 in control: disable S1-S3 port in |
| | | node S1, switch to backup network |
| | | path NC2-S2-S4-D1B, and trigger |
| | | alarm in human machine interface. |
| (5) | S3-S4 | (1) If NC1 in control: maintain primary network |
| | Connection Fails | path NC1-S1-S3-D1A, and trigger alarm |
| | | in human machine interface. |
| | | (2) If NC2 in control: maintain primary |
| | | network path NC2-S2-S1-S3-D1A, |
| | | and trigger alarm in human |
| | | machine interface. |
| (6) | Port A in D1 | (1) If NC1 in control: disable S3-D1A |
| | Fails | connection, switch to backup network path |
| | | NC1-S1-S3-S4-D1B, and trigger |
| | | alarm in human machine interface. |
| | | (2) If NC2 in control: disable S3-D1A connection, |
| | | switch to backup network path |
| | | NC2-S2-S1-S3-S4-D1B,and trigger |
| | | alarm in human machine interface. |

The “human machine interface” is preferably a computer terminal that is used to input commands into and monitor the status of the primary and/or secondary network controllers 210a and 210b.

The primary network controller 210a and the secondary network controller 210b preferably perform periodic tests of the backup network paths. In the system 200 of FIG. 2 the even numbered nodes S2, S4, S6, Sn, etc., and the connections between them are used for the backup network paths, and are preferably checked periodically by the primary network controller 210a and the secondary network controller 210b.

Because the control and data acquisition system 200 can switch to a backup network path that is already, determined, should a primary network path fail, there is little or no down time associated with the failure of a primary network path. Thus, the control and data acquisition system 200 is particularly suited for mission-critical applications such as, for example, monitoring the status of an electrical power grid.

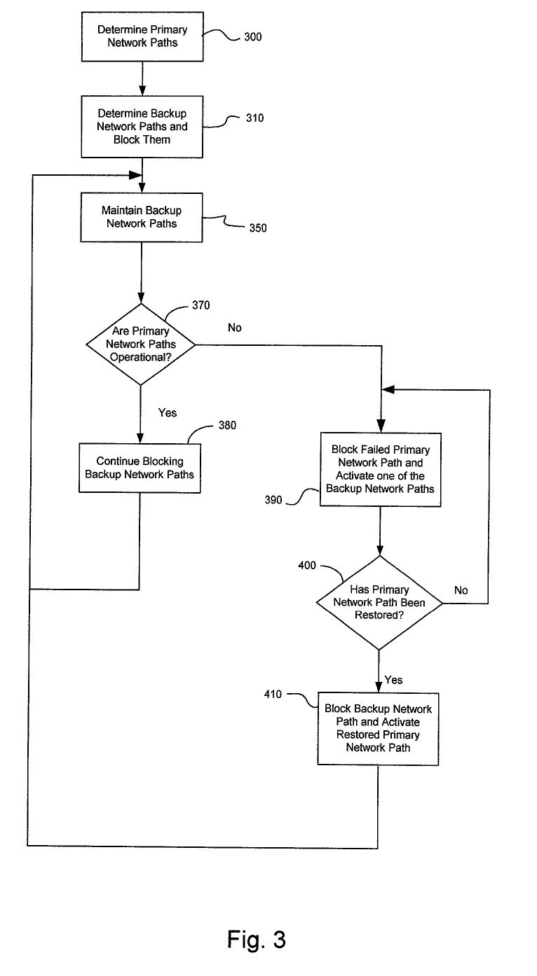

FIG. 3 is a flowchart of a preferred control routine for network controllers 110, 210a and 210b. The routine starts at step 300, where primary network paths between the network controller and the network devices are determined. Next, at step 310, backup network paths are determined, stored in the network controllers and blocked.

The routine then proceeds to step 350, where the backup network paths are maintained by checking them periodically for failures. Next, at step 370, the control routine determines if the primary network paths are operational. If all primary network paths are operational, control continues to step 380. Otherwise, control jumps to step 390.

At step 380, the control routine continues to block the backup network paths to prevent loops. Control then returns to step 350.

At step 390, the control routine blocks the failed primary network path and activates one of the backup network paths. Control then continues to step 400, where the control routine determines if the failed primary network path has been restored. If the failed primary network path has been restored, control continues to step 410. Otherwise, control returns to step 390.

At step 410, the control routine blocks the backup network path that was activated at step 390 and re-activates the restored primary network path. Control then returns to step 350.

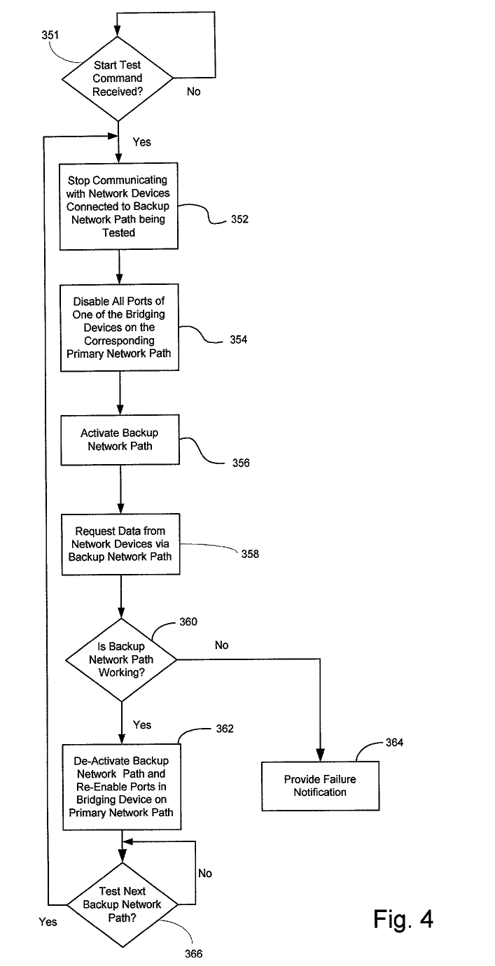

FIG. 4 is a flowchart of a preferred control routine for testing the backup network paths, which is preferably periodically performed as part of the “maintain backup network paths” step 350 of FIG. 3.

The routine starts at step 351, where the network controller determines if a command to start testing as been received. If it has, control continues to step 352. Otherwise, the network controller continues to wait for a command to start the testing.

At step 352, the network controller stops communicating with network devices connected to the backup network path being tested. Next, at step 354, the control routine disables the ports of one of the bridging devices on the corresponding primary network path. This forces the network devices connected to the backup network path being tested to switch to their backup data ports.

The routine then continues to step 356, where the backup network path being tested is activated. Then, at step 358, the network controller requests data from the network devices via the backup network path.

At step 360, the control routine determines whether the backup network path is working. If the backup network path is working, control continues to step 362, where the backup network path is de-activated and the ports of the bridging device disabled at step 354 are re-enabled, thereby causing the network devices to switch back to the primary data port. Otherwise, control skips to step 364, where a failure notification is provided to a network administrator or anyone else responsible for the network.

At step 366, the network controller determines if it is time to test another backup network path. The network controller preferably waits a predetermined period of time before testing another backup network path. Alternatively, the network controller could be configured to wait for a manually entered command from a user before testing the next backup network path. Once the predetermined period of time has elapsed, or the manually entered command has been received, control returns to step 352.

The network segments between the bridging devices (120a, 120b, and 220a-220h) and the network devices (130a-130c and 230a-230i) that form the primary and backup network paths can be implemented with twisted-pair cables, fiber optic cables, coaxial cables, wireless connections or any other type of connection. The network protocol used for the network 100 and the control and data acquisition system 200 is preferably an Ethernet protocol. However, any network protocol can be used, while still falling within the scope of the present invention.

The network controllers 110, 210a and 210b of the present invention are preferably implemented on a server, which may be or include, for instance, a work station running the Microsoft Windows™ NT™, Windows™ 2000, UNIX, LINUX, XENIX, IBM, AIX, Hewlett-Packard UX™, Novel™, Sun Micro Systems Solaris™, OS/2™, BeOS™, Mach, Apache Open Step™, or other operating system or platform. However, the network controllers 110, 210a and 210b of the present invention could also be implemented on a programmed general purpose computer, a special purpose computer, a programmed microprocessor or microcontroller and peripheral integrated circuit elements, an ASIC or other integrated circuit, a hardwired electronic or logic circuit such as a discrete element circuit, a programmable logic device such as a FPGA, PLD, PLA, or PAL, or the like. In general, any device on which a finite state machine capable of implementing the control routines illustrated in FIGS. 3 and 4 can be used to implement the present invention.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

What is claimed is:

1. A network, comprising:
a primary network controller; and
a plurality of network devices, wherein each network device is connected to the primary network controller by a respective primary network path; and
at least one predetermined primary backup network path connecting each network device with the primary network controller, wherein each predetermined primary backup network path is blocked by the network controller when a corresponding primary network path is active;
wherein, when a primary network path between a network device and the primary network controller fails, the primary network controller blocks the failed primary network path and switches to one of the predetermined primary backup network paths.

2. The network of claim 1, wherein the primary network controller periodically tests a condition of the predetermined backup network paths.

3. The network of claim 1, further comprising:
a secondary network controller that takes over control of the network if the primary network controller fails, wherein each network device is connected to the secondary network controller by a respective secondary network path;
at least one predetermined secondary backup network path connecting each network device with the secondary network controller, wherein each predetermined secondary backup network path is blocked by the network controller when a corresponding secondary network path is active;
wherein, when a secondary network path between a network device and the secondary network controller fails, the secondary network controller blocks the inoperable secondary network path and switches to one of the predetermined secondary backup network paths.

4. The network of claim 3, wherein the secondary network controller periodically tests a condition of the predetermined secondary backup network paths.

5. The network of claim 1, wherein at least a portion of the respective primary network paths and at least a portion of the predetermined primary backup network paths each comprise a 10 megabit per second connection.

6. The network of claim 5, wherein the 10 megabit per second connection comprises an Ethernet 10Base-T connection.

7. The network of claim 5, wherein the 10 megabit per second connection comprises twisted-pair cable, fiber optic cable and/or coaxial cable.

8. The network of claim 5, wherein the 10 megabit per second connection comprises a wireless connection.

9. The network of claim 1, wherein at least a portion of the respective primary network paths and at least a portion of the predetermined primary backup network paths each comprise a 100 megabit per second connection.

10. The network of claim 9, wherein the 100 megabit per second connection comprises an Ethernet 100Base-T connection.

11. The network of claim 9, wherein the 100 megabit per second connection comprises twisted-pair cable, fiber optic cable and/or coaxial cable.

12. The network of claim 9, wherein the 100 megabit per second connection comprises a wireless connection.

13. The network of claim 1, wherein the primary network controller comprises a computer.

14. The network of claim 1, wherein the respective primary network paths and the predetermined primary backup network paths each comprise a plurality of network bridges.

15. The network of claim 14, wherein the plurality of network bridges comprise a plurality of Ethernet switches.

16. The network of claim 1, wherein at least some of the network devices comprise universal relays.

17. The network of claim 1, wherein at least some of the network devices comprise process controllers.

18. A control and data acquisition system comprising the network of claim 1.

19. The control and data acquisition system of claim 18, wherein the primary network controller monitors a status of an electrical power grid through the network.

20. A control and data acquisition system, comprising:
at least one network controller;
a plurality of universal relays;
a plurality of process controllers, wherein each universal relay and each process controller is connected with the at least one network controller by a respective primary network path; and
predetermined backup network paths connecting each universal relay and each process controller with the at least one network controller, wherein each predetermined backup network path is blocked by the at least one network controller when a corresponding primary network path is active;
wherein, when a primary network path fails, the at least one network controller blocks the failed primary network path and switches to one of the predetermined backup network paths.

21. The system of claim 20, wherein the at least one network controller periodically tests a condition of the predetermined backup network paths.

22. The system of claim 20, wherein at least a portion of the respective primary network paths and at least a portion of the predetermined backup network paths each comprise a 10 megabit per second connection.

23. The system of claim 22, wherein the 10 megabit per second connection comprises an Ethernet 10Base-T connection.

24. The system of claim 22, wherein the 10 megabit per second connection comprises twisted-pair cable, fiber optic cable and/or coaxial cable.

25. The system of claim 22, wherein the 10 megabit per second connection comprises a wireless connection.

26. The system of claim 20, wherein at least a portion of the respective primary network paths and at least a portion of the predetermined backup network paths each comprise a 100 megabit per second connection.

27. The system of claim 26, wherein the 100 megabit per second connection comprises an Ethernet 100Base-T connection.

28. The system of claim 26, wherein the 100 megabit per second connection comprises twisted-pair cable, fiber optic cable and/or coaxial cable.

29. The system of claim 26, wherein the 100 megabit per second connection comprises a wireless connection.

30. The system of claim 20, wherein the at least one network controller comprises at least one computer.

31. The system of claim 20, wherein the respective primary network paths and the predetermined backup network paths each comprise a plurality of network bridges.

32. The system of claim 31, wherein the plurality of network bridges comprise a plurality of Ethernet switches.

33. A method of implementing a network, comprising the steps of:
determining a primary network path between a network controller and a network device, wherein the network controller and the network device exchange data over the primary network path;
determining, prior to a failure of the primary network path, a backup network path between the network controller and the network device;
monitoring a status of the primary network path;
blocking the backup network path while the primary network path is active; and
blocking the primary network path and making the backup network path active when the primary network path fails.

34. The method of claim 33, further comprising the step of periodically monitoring a condition of the backup network path.

35. The method of claim 33, wherein the network device comprises a universal relay.

36. The method of claim 33, wherein the network device comprises a process controller.

37. The method of claim 33, wherein the primary network path and the backup network path comprise network bridges.

38. A computer programmed with a network monitoring program, wherein the network monitoring program, when executed by the computer, performs the steps of:
determining a primary network path between a network controller and a network device, wherein the network controller and the network device exchange data over the primary network path;
determining, prior to a failure of the primary network path, a backup network path between the network controller and the network device;
monitoring a status of the primary network path;
blocking the backup network path while the primary network path is active; and
blocking the primary network path and making the backup network path active when the primary network path fails.

39. The computer of claim 38, wherein the network monitoring program performs the further step of periodically monitoring a condition of the backup network path.

40. The computer of claim 38, wherein the network device comprises a universal relay.

41. The computer of claim 38, wherein the network device comprises a process controller.

42. The computer of claim 38, wherein the primary network path and the backup network path comprise network bridges.

43. The computer of claim 49, wherein the network bridges comprise Ethernet switches.
